(19) United States
(12) Patent Application Publication
(10) Pub. No.: US 2025/0096700 A1
(43) Pub. Date: Mar. 20, 2025

(54) AUXILIARY RESONANT COMMUTATED POLE CONVERTER WITH SELF VOLTAGE BALANCING CAPABILITY

(71) Applicants: HILLCREST ENERGY TECHNOLOGIES LTD., Vancouver (CA); SYSTEMATEC GMBH, Landsberg am Lech (DE)

(72) Inventors: Jamal AMINI, Vancouver (CA); Ari BERGER, Vancouver (CA); Harald HENGSTENBERGER, Landsberg am Lech (DE)

(21) Appl. No.: 18/843,213

(22) PCT Filed: Mar. 3, 2023
(86) PCT No.: PCT/CA2023/000013

§ 371 Date: Aug. 30, 2024

Related U.S. Application Data
(60) Provisional application No. 63/316,267, filed on Mar. 3, 2022.

(51) Int. Cl. H02M 7/483; H02M 1/00; H02M 1/10; H02M 1/44; H02M 7/48

(52) U.S. Cl. CPC H02M 7/4833; H02M 1/0058; H02M 1/10; H02M 1/44; H02M 7/4815

(57) ABSTRACT

A zero-voltage switching ARCP-based converter that is capable of balancing its DC-link capacitor voltages and a method of balancing the voltages of the DC-link capacitors of an ARCP-based converter are disclosed herein. Each phase of the converter comprises a main section, an auxiliary section, and a control section. Main switches of the main section synthesize one or more reference voltage at the output of the phase. The auxiliary section facilitates zero voltage switching of the main switches. The control section provides gate signals for the main switches and the auxiliary switches based on the feedback signals from the converter to control the main and the auxiliary circuits. The method balances the voltages of the DC-link capacitor by utilizing ARCP-based hardware. The disclosed method minimizes switching losses and other EMI problems experienced by other converters.

### FIELD

The present disclosure relates to a resonance converter, and in particular an auxiliary resonant commutated pole converter.

### BACKGROUND OF THE DISCLOSURE

Converters play an important role in various aspects of daily life including in transportation, entertainment, and energy, and are integral components of machinery used in applications such as, but not limited to, electrical drives, electric vehicles, renewable energy harvesting, and power conditioning. In recent years, in part because of the increased attention to carbon-emission reduction and renewable energy harvesting, the use of converter s in power systems has been increasing.

Because of converter switches' non-idealities, undesired energy losses are generated during the operation of converters. Such energy losses are generally made up of two forms of losses: conduction losses and switching losses. Switching losses manifest themselves as heat on the switches. This heat reduces the effective life of the converter switch, and in turn the efficiency and the reliability of the converter. Switching losses also limit the maximum switching frequency at which the converter can operate. The limited switching frequency in turn hinders the converter's ability to achieve better output power quality and higher power density and to operate at a lower cost. Increasing switching frequency leads to better power quality and smaller passive component values, thereby improving at least the cost-effectiveness of the converter.

Higher switching frequencies in a converter may be achieved by reducing the switching losses; the reduction of switching losses lower the junction temperature of the converter. Lower losses reduce energy consumption and carbon emission, thereby rendering the power system more environment-friendly. Therefore, reducing losses such as switching losses is of great interest to those who design converters. Electromagnetic compatibility (EMC) of power converters is also another important aspect of interest, considering that the number of sensitive loads (e.g., data processing systems) that a power grid can bear continues to increase.

In power semiconductor devices, switching losses arise as a result of the overlapping of rising and falling edges of the voltage over the devices with falling and rising edges of the current flowing through the devices, respectively.

A way to reduce switching losses is by shortening the overlapping time via increasing rising and falling rates of the current and the voltage. Wide-bandgap devices are examples of devices that exhibit shortened overlapping time. Although wide-bandgap devices have lower switching losses compared to silicon-based devices, their utilization may lead to unintended consequences like electromagnetic interference (EMI) challenges and problems related to high dv/dt which in turn may damage some loads like motors.

Another way of reducing switching losses is by adopting a zero voltage switching scheme which is based on a resonance circuit. A resonance circuit turns the voltage over the switching device zero before the switching event and eliminates overlap between transition edges of voltage and current, which leads to zero switching losses.

Several soft-switching methods have been proposed to reduce switching losses. For example, the auxiliary resonant commutated pole (ARCP) proposed in U.S. Pat. No. 5,047,913 by R. De Doncker et al. (“Doncker”) reduces switching losses for a two-level converter (a “Doncker converter”). As shown in FIG. 1 in Doncker, the Doncker converter has an auxiliary branch consisting of two reverse-series connected switches, an inductor, and two resonance capacitors connected to main circuit which is two-level half-bridge converter. However, since mid-point voltage of the Doncker converter drifts as result of the tolerance of the component values and working and load conditions, its performance and application are practically limited. Such voltage drift reduces the effectiveness of the zero or near-zero voltage switching (ZVS) scheme and exhibits switching losses. Furthermore, if the mid-point voltage deviation exceeds a certain limitation, damage to some of the components of the circuit may result. This issue makes ARCPs utilization limited in industrial applications, especially applications with highly-dynamic loads and harsh environments. Two methods proposed in U.S. Publication No. 2015/0318794A1 and U.S. Pat. No. 9,344,007B2 attempt to address this problem; however, the innovations taught therein use two extra switches and one extra inductor, and such additions lead to higher cost, volume, and losses. Moreover, since added switches do not switch at zero current, an EMI problem also may be inadvertently introduced in addition to the introduction of higher losses. To solve the mentioned problems due to mid-pint deviation without creating new problem, a new method which does not use extra power hardware is proposed herein.

### SUMMARY OF THE DISCLOSURE

According to a part of the disclosure, there is a zero-voltage switching ARCP-based converter that is capable of balancing its DC-link capacitor voltages. This converter can have any number of phases. Each phase of this converter comprises a main section, an auxiliary section, and a control section. Main switches synthesize one or more reference voltage at the output of the phase using DC-link voltage. The auxiliary circuit facilitates zero voltage switching of the main switches. The control section provides gate signals for the main and the auxiliary switches based on the feedback signals from the converter to control the main and the auxiliary circuits and to provide desired voltage at the output while guarantee zero voltage switching of the main switches and zero current switching of the auxiliary switches and balanced split DC-link. These tasks are done by regulating the switches' “ON” and “OFF” time intervals and overlap interval of “ON” state of auxiliary and main switches based on the feedback signals. This method balances DC-link capacitor voltages by utilizing ARCP's existing hardware. Since auxiliary circuit switch at zero current, this method does not increase switching losses and EMI problems.

According to another part of the disclosure, there is a converter comprising a phase, the phase comprising: (a) a power section comprising a main section and an auxiliary section; and (b) a control section for receiving information from a current detection device and a voltage detection device, the current detection device and voltage detection device for providing the information to the control section regarding a state of the converter. The main section comprises two main switches connected in series and two DC-link capacitors connected in series. The auxiliary section comprises: (A) two resonance capacitors, wherein one of the two resonance capacitors is connected in parallel with one of the two main switches and another of the two resonance capacitors is connected in parallel with another of the two main switches; and (B) an auxiliary branch comprising two auxiliary switches, two auxiliary diodes and a resonance inductor.

The voltage detection device may be any one of a voltage sensor and a voltage estimator.

The two DC-link capacitors may be connected in series and disposed between a positive rail and a negative rail of the phase.

The auxiliary branch connects the output point of the phase to a midpoint that is located between the two resonance capacitors.

One of the two auxiliary switches may be connected in parallel to one of the two auxiliary diodes, and another of the two auxiliary switches may be connected in parallel to another of the two auxiliary switches.

The control section may comprise a primary control subsection and a secondary control subsection. The primary control subsection may use one or more feedback signals to synthesize a reference signal at the output point of the phase for achieving zero voltage switching. The secondary control subsection may be adapted to generate one or more gating signals based on one or more status signals received from the primary control subsection and the voltage detection device, the one or more gating signals for keeping the voltage levels of the two DC-link capacitors balanced while the primary control subsection synthesizes the reference signal at the output point of the phase.

The converter may comprise a plurality of phases, each phase being adapted to convert any one of AC/DC, DC/AC and DC/DC.

According to another part of the disclosure, there is a method of achieving zero voltage and zero current switching in a converter, the method comprising: (i) sending to the control section information that is related to the current level at the output of the phase and the voltage level of the DC link capacitors; (ii) regulating ON and OFF time intervals of each of the main switches and their overlap with the ON state of the auxiliary switches; and (iii) manipulating the duration of the ON and OFF time intervals of each of the auxiliary switches and each of their overlap time with the main switches; thereby keeping the voltages of the DC link capacitors balanced.

Information related to a deviation between the voltage levels of the DC-link capacitors is sent through a controller located in a secondary control subsection of the control section. The controller generates an output based on the information. A capacitor voltage balancing algorithm factors the output into the charging and discharging times of the DC-link capacitors. The coordination of these steps keeps the voltages of the DC link capacitors balanced.

The controller may be a P controller, I controller, PI controller, PID controller, sliding mode controller, deadbeat controller, or a digitalized continuous-time domain controller.

The secondary control subsection may be implemented in a discrete time domain.

This summary does not necessarily describe the entire scope of all aspects of the disclosure. Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 is a schematic diagram of a phase of an ARCP converter.

FIG. 2 is a block diagram of the control section of the phase of FIG. 1.

FIG. 3 is a block diagram of the DC voltage balancing algorithm used in the phase of FIG. 1.

FIG. 4 is a graph that illustrates the performance of the DC voltage balancing system applied to the phase of FIG. 1.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Any element expressed in the singular form also encompasses its plural form. Any element expressed in the plural form also encompasses its singular form. The use of the word “a” or “an” when used herein in conjunction with the term “comprising” may mean “one”, but it is also consistent with the meaning of “one or more”, “at least one”, and “one or more than one”.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counter part pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

In this disclosure, the term “Ix” refers to auxiliary branch current.

In this disclosure, the term “mid-point voltage” or derivative thereof means the voltage across a capacitor.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disdosed herein may be performed by more, fewer, or other components and the methods described may include more, fewer, or other steps. Additionally, steps may be performed in any suitable order. As used in this document, “each” refers to each member of a set or each member of a subset of a set.

A resonance converter with improved control method for achieving ZVS is described in this present disclosure. Such converter has improved DC-link voltage regulation, and accordingly, improves ZVS and output power quality and reduces stress on the switches and capacitor.

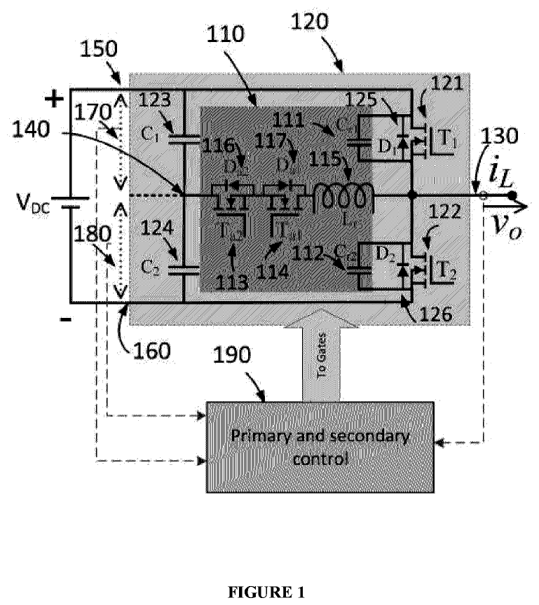

The resonance converter is based on a Auxiliary Resonance Commutated Pole (ARCP) circuit and comprises a new control to overcome the limitations of existing soft-switching converters. ARCP comprises auxiliary circuit which is connected to the middle point of the DC link and phase output. There is a resonance capacitor (e.g., resonance capacitor 111 and resonance capacitor 112 in FIG. 1 herein) paralleled with every main switch (e.g. switch 121 and switch 122 in FIG. 1 herein) of the converter. The auxiliary circuit further comprises two switches and an inductor. The converter's main power semiconductors, with help of auxiliary circuit, switch at zero voltage (soft switching), leading to considerable reduction of switching losses of the converter and EMIs related to switching.

In an ARCP-based converter, in order to ensure that the main switches of the converter switch at zero voltage, the resonant inductor has to be charged to a calculated level of current via one of the DC-link capacitors before starting switch state transition in the main switches. Charging the inductor sometimes does not take equal energy from upper and lower capacitors and causes voltage deviation of these two capacitors from nominal value. Component value tolerances and load characteristics are other causes of voltage deviation of the DC-link capacitor voltages. For example, manufacturing tolerance of the capacitor value and loads driven by voltage with low frequency can cause considerable drift of the mid-point voltage.

Mid-point voltage deviation not only introduces some switching losses and affect ZVS performance, but also puts stress on switches and other components. In addition, mid-point voltage deviation introduces low order harmonics (especially even-order harmonics which has more detrimental effects on power systems compared to odd-order harmonics) to the output of the converter and reduce output power quality.

To address the specific issues described in the preceding paragraph, the resonance converter with proposed control method described herein is adapted to keep the mid-point voltage of the DC-link capacitors regulated and balanced (i.e., the measured voltages of the DC-link capacitors are approximately similar or approximately equal) during working and load conditions, thereby producing soft switching and better power quality of the converter for AC/DC, DC/AC, and back-to-back AC/DC/AC power converters with arbitrary number of phases. The method described herein reduces switching losses, voltage stress on the switches, EMI, and filtering and heat management requirements, and makes the converter more compact and efficient compared to other soft-switching converters.

Referring to FIG. 1, and according to an embodiment of a converter described herein, there is shown a phase (pole) of a converter.

A multi-phase converter can be built with a multiple of this pole in parallel on the DC side. Since the structures for all phases are similar, one pole will be described herein in greater detail.

As shown in FIG. 1, the pole consists of two sections: main section 120 and auxiliary section 110. Main section 120 comprises main switch 121 (also identified as T₁ in FIG. 1) and main switch 122 (also identified as T₂ in FIG. 1), and DC link capacitor 123 (also identified as C₁ in FIG. 1) and DC link capacitor 124 (also identified as C₂ in FIG. 1). Auxiliary section 110 comprises resonance capacitor 111 (also identified as Cr₁ in FIG. 1) and resonance capacitor 112 (also identified as Cr₂ in FIG. 1) in parallel with main switch T₁ and main switch T₂, auxiliary switch 113 (also identified as Tₐ₁ in FIG. 1) and auxiliary switch 114 (also identified as Tₐ₂ in FIG. 1), auxiliary diode 116 (also identified as Dₐ₁ in FIG. 1) and auxiliary diode 117 (also identified as Dₐ₂ in FIG. 1), and a resonance inductor 115 (also identified as Lᵣ in FIG. 1).

Main switch 121 and main switch 122 are connected in series between the positive rail 150 of the DC link and the negative rail 160 of the DC link in a manner such that the drain of switch 121 is connected to the positive rail 150 and the source of switch 121 is connected to the output point of converter 130. The source of switch 122 is connected to the negative rail 160 of the DC link, and the drain of switch 122 is connected to the output point of converter 130.

Main switch 121 has a main diode 125, and a resonance capacitor 111 and main switch 121 are connected in parallel. Main switch 122 has a main diode 126, and a resonance capacitor 112 and main switch 122 are connected in parallel. DC link capacitors 123 and 124 have the same value and are connected in series between the positive rail 150 of the DC link and the negative rail 160 of the DC link. These DC link capacitors split the DC link voltage into two voltages (VDC1 and VDC2, wherein each voltage nominally should be VDC/2). Auxiliary switches 113 and 114 and auxiliary diodes 116 and 117, along with resonance inductor 115, collectively make an auxiliary branch (un-numbered) that connects output point of the converter 130 and the middle point 140 (midpoint) of the DC link. In this auxiliary branch (un-numbered): (i) auxiliary diode 116 is connected in parallel with auxiliary switch 113; and (ii) auxiliary diode 117 is connected in parallel with auxiliary switch 114. Auxiliary switches (113, 114) are used to charge resonance inductor 115 to a required current level to fully discharge and charge resonance capacitors (111, 112) as required. This current is called the “Auxiliary Branch Current” (Ix). To calculate this current, the load current “i” need to be sensed or estimated, by a sensor or estimator, and fed back to the control algorithm. In addition, the pole comprises voltage sensor 170 and voltage sensor 180 for measuring the voltages of the DC link capacitors (123, 124). The measured values are used in DC voltage regulation control algorithm.

In some embodiments, metal-oxide-semiconductor field-effect transistors (MOSFETS) are used as components of the phase. In other embodiments, insulated-gate bipolar transistors (IGBTs) are used instead MOSFETS are used as components of the phase, and in such embodiments, the drain and source are equivalent with collector and emitter, respectively.

Zero (or near-zero) voltage and zero (or near-zero) current switching in the converter is achieved by pairing the converter with an appropriate method of operation. Generally, such method comprises: (i) sending to the control section information that is related to the current level at the output of the phase and the voltage level of the DC link capacitors; (ii) regulating ON and OFF time intervals of each of the main switches and their overlap with the ON state of the auxiliary switches; and (iii) manipulating the duration of the ON and OFF time intervals of each of the auxiliary switches and each of their overlap time with the main switches; thereby keeping the voltages of the DC link capacitors balanced.

When the switching transition is completed, main switches 121 and 122 are in complementary states. That is, when main switch T₁ is “ON”, main switch T₂ is “OFF”, and when main switch T₁ is “OFF”, main switch T₂ is “ON”. Therefore, 4 modes of transition exist: (i) Mode 1, from main switch T₁ (“ON”) and main switch T₂ (“OFF”) to switch T₁ (“OFF”) and main switch T₂ (“ON”), wherein load current (it) is positive (outward—from the inverter towards the load); (ii) Mode 2, which has the same transition as Mode 1 when load current (it) is negative (inward—from the load into the inverter); (iii) Mode 3, from main switch T₁ (“OFF”) and main switch T₂ (“ON”) to main switch T₁ (“ON”) and main switch T₁ (“OFF”), wherein load current (i_{L}) is positive; and (iv) Mode 4, which has the same transition as Mode 3 when load current (i_{L}) is negative.

In Mode 1, wherein T₁ is “ON” and T₂ is “OFF” with a positive load current, Tₐ₁ is turned “ON” in the first step. Since T₁ is already “ON”, the resonance inductor 115 connects to DC-link capacitor C₁, and inductor 115's current increases linearly. In step 2, after Ix is built up in Lᵣ, T₁ is turned “OFF”. After turning T₁ “OFF”, Ix continues to flow and finds its way through resonance capacitors Cn and Cᵣ₂ and forms a resonance tank consisting of Lᵣ, Cᵣ, and Cᵣ₂. The resonance tank charges Cᵣ₁ to VDC and discharges Cᵣ₂ to zero. In step 3, when Cᵣ₂ reaches zero volts, T₂ is turned “ON” at zero voltage without facing switching losses. In this step, since voltage on the inductor 115 is reversed, the inductor current starts to drop. In step 4, when the inductor current reaches zero, Tₐ₁ is turned “OFF” with no switching losses, and transition is completed. Step 1 discharges C₁ and step 3 charges C₂. Therefore, when C₁ has more voltage than C₂, with extending step 1 interval and consequently step 3 interval, C₁ and C₂ voltages can be balanced. To secure zero current switching of auxiliary switches, step 2 and step 3 have same time interval in all modes.

Switching sequence of Mode 2 is similar to Mode 1. The difference between Mode 2 and Mode 1 is the amount of the Ix. In Mode 2, i_{L} has an adverse effect on the required charging states of Cᵣ₁ and Cᵣ₂; therefore, Ix should provide i_{L} in transition and therefore Ix has a larger value in Mode 2 than in Mode 1. The Ix in Mode 2 has same effect on DC link capacitors as the Ix in Mode 1 has. Therefore, similar to Mode 1 where C₁ has more voltage than C₂, their voltage can be balanced by manipulating the duration of step 1 and the duration of step 3.

In Mode 3, wherein T₂ is “ON” and T₁ is “OFF”, Tₐ₂ is turned ON in a first step. Since T₂ is already ON, the resonance inductor 115 connects to the DC-link capacitor C₂, and the current increases linearly in Lᵣ in the opposite direction to that of Mode 1. In Mode 3, since i_{L} has an adverse effect on the desired charge state of the resonance capacitors for transition, it is desired that Ix provides i_{L} in addition to the current required to compensate for losses in the circuit. The step 1 interval is controlled to build this current in the resonance inductor with part of energy stored in C₂. In other words, step 1 discharges C₂. In step 2, after the current is built in Lᵣ, T₂ will be turned “OFF”. After T₂ is turned “OFF”, Ix takes over providing i_{L}, and the rest of Ix flows through the resonance capacitors Cᵣ₁ and Cᵣ₂; a resonance tank consisting of Lᵣ, Cᵣ₁, and Cᵣ₂ forms. Cᵣ₂ is charged to VDC, and Cᵣ₁ is discharged to zero. At step 3, when Cᵣ₁ reaches zero volt, T₁ is turned “ON” at zero voltage without facing switching losses. In this step, since voltage on the inductor 115 is reversed compared to step 1, the inductor current starts to drop and charge C₁. At step 4, when the inductor current reaches zero, Tₐ₂ is turned OFF with no switching losses, and transition is completed. Step 1 discharges C₂, step 3 charges C₁. Therefore, when C₂ has more voltage than C₁, with extending step 1 interval and consequently step 3 interval, C₁ and C₂ voltages can be balanced. At step 4, when the inductor current reaches zero, Tₐ₂ is turned OFF with no switching losses, and the transition is completed.

The switching sequence of Mode 4 is similar to that of Mode 3. The difference between Mode 4 and Mode 3 is the amount of the Ix. In Mode 3, i_{L} has a desirable effect on the required charging states of Cᵣ₁ and Cᵣ₂; as a result, Ix in Mode 4 has a smaller value compared to Ix in Mode 3. Therefore, similar to Mode 3 when C₂ has more voltage than C₁, their voltage can be balanced by manipulating the duration of step 1 and the duration of step 3.

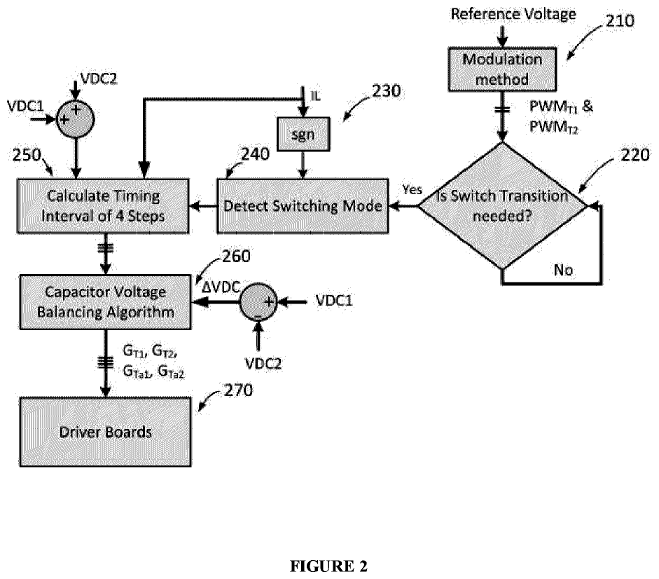

Referring to FIG. 2, there is shown a block diagram of the primary control subsections and secondary control subsections of control section 190 of the converter, a part of which is depicted FIG. 1. At step 210, pulses for main switches are generated based on a reference voltage. If a transition in switching states is requested in the affirmative at step 220, block 240 proceeds to determine the switching mode based on direction of load current, which is detected at step 230, and the present state of the main switches. At step 250, the timing of four steps considering total DC-link voltage and it is calculated. The timing for Step 1 and Step 2 of the four steps are called charging time (CT) and deadtime (DT), respectively. The timing of Step 3 equals to that of Step 1. These timings are sent to the capacitor voltage balancing algorithm at step 260. The capacitor balancing algorithm modifies the received timings according to charge requirements of the capacitors to keep capacitor voltages balanced and generates reference output voltage while guarantees zero voltage switching in main switches and zero current switching in auxiliary switches. Afterwards, these pulses are passed to associated gate drivers at step 270.

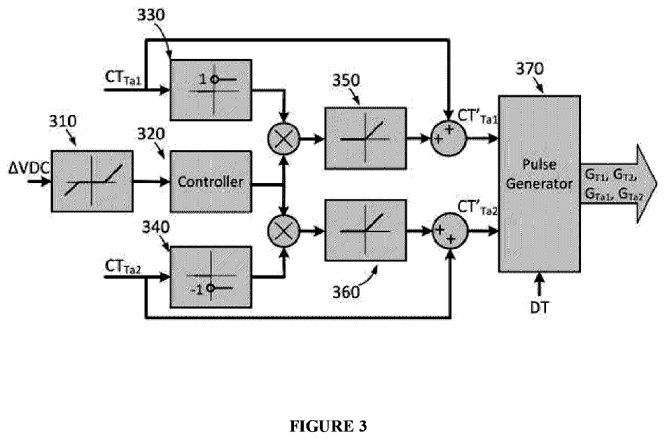

FIG. 3 is a block diagram of the DC voltage balancing algorithm used in the phase of FIG. 1. A measurement recording the difference of the upper and lower capacitors' (C₁ and C₂ respectively) voltages is sent to a controller 320 after passing through a dead-band block 310. The controler output is multiplied by a step function of CT of Tₐ₁ 330 and a negative of a step function of CT of Tₐ₂ 340. These values pass through clip function blocks 350 and 360 which limits the lower band to zero. Blocks 330 through 360 help to choose appropriate CT interval to be modified to balance DC-link capacitor voltages. The output of these blocks are added to associated charging time. Since CT_{Ta1} and CT_{Ta2} have opposite effect on mid-point voltage, at least one of CT times is zero at any specific time. At the end, firing pulse for the main and auxiliary switches are generated by pulse generator 370 considering dead-time and charging time. In other embodiments, there is no dead-band block. In other embodiments, the measurement recording the difference of the upper and lower capacitors' (C₁ and C₂ respectively) voltages is sent to a controller without passing through a dead-band block.

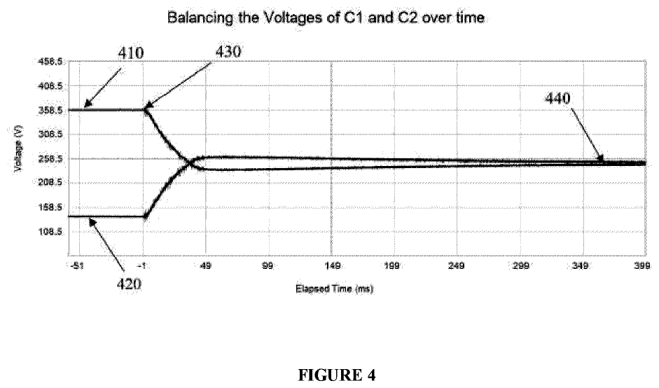

FIG. 4 shows the performance of the converter. As depicted, the DC-link capacitor voltage balancing algorithm can compensate for the initial DC-link capacitor voltage deviation between C₁ and C₂, keeping the voltages of between C₁ and C₂ balanced during operation of the converter while minimizing adverse effects on the converter. Namely, C₁ voltage 410 and C₂ voltage 420 have an initial capacitor deviation. At point 430, the DC-link capacitor voltage balancing algorithm is engaged by control section 190 which, over time, balances voltage 410 and C₂ voltage 420 (see for example balanced mid-point 440 where voltage 410 equals C₂ voltage 420).

By applying firing pulses generated by pulse generator 370, desired output can be generated by the converter with negligible switching losses thereby mitigating EMI and dv/dt problems. Furthermore, because of the reduced heat management requirement, the power density of a converter comprising the apparatus described herein is higher than conventional converters in same power range. Capacitor voltage balancing algorithm also helps to reduce switching losses and EMI compared to conventional ARCP and lower stress on the converter's components.

In an aspect, there is provided a high efficiency converter based on a novel ARCP with capability of DC capacitor voltage regulation. The converter can have one or more phases in which each phase includes two main switches with associated anti-parallel diodes that are connected between the phase output and positive and negative rails of a DC link. The switches can be, for example, IGBT or MOSFET. Two resonance capacitors are connected in paralleled with each main switch. In another aspect, there is provided a DC link with split voltage that has two capacitors, one connected in series between a positive rail of the DC link and a midpoint, and the other between the midpoint and the negative rail. An auxiliary branch can include two switches and a variable inductor that is connected between a midpoint of the DC link and an output of the phase. One of the switches can be connected between a DC link midpoint and inductor, and the other of the switches can be connected between a phase output and the other end of the inductor. In an aspect of a control method, instead of time intervals, load current can be used to determine value of the charging times adjustment. In another aspect of the control method, any discrete-domain and continuous-domain can be used in the algorithm. In another aspect, estimator can be use instead voltage sensors in the phase.

The method disclosed herein improves zero (or near-zero) voltage switching compared to conventional ARCPs.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. A converter comprising a phase, the phase comprising:
(a) a power section comprising a main section and an auxiliary section;
(i) the main section comprising two main switches connected in series and two DC-link capacitors connected in series; and
(ii) the auxiliary section comprising: (A) two resonance capacitors, wherein one of the two resonance capacitors is connected in parallel with one of the two main switches and another of the two resonance capacitors is connected in parallel with another of the two main switches; and (B) an auxiliary branch comprising two auxiliary switches, two auxiliary diodes and a resonance inductor; and
(b) a control section for receiving information from a current detection device and a voltage detection device, the current detection device and voltage detection device for providing the information to the control section regarding a state of the converter.

2. The converter as claimed in claim 1, wherein the current detection device is any one of a current sensor and a current estimator.

3. The converter as claimed in claim 1, wherein the voltage detection device is any one of a voltage sensor and a voltage estimator.

4. The converter as claimed in claim 1, wherein the two DC-link capacitors are connected in series and located between a positive rail and a negative rail of the phase.

5. The converter as claimed in claim 4, wherein the auxiliary branch connects the output point of the phase to a midpoint that is located between the two resonance capacitors.

6. The converter as claimed in claim 1, wherein one of the two auxiliary switches is connected in parallel to one of the two auxiliary diodes, and wherein another of the two auxiliary switches is connected in parallel to another of the two auxiliary switches.

7. The converter as claimed in claim 1, wherein the converter comprises a plurality of phases, each phase being adapted to convert any one of AC/DC, DC/AC and DC/DC.

8. The converter as claimed in claim 1, wherein the control section comprises a primary control subsection and a secondary control subsection.

9. The converter as claimed in claim 8, wherein the primary control subsection uses one or more feedback signals to synthesize a reference signal at the output point of the phase for achieving zero voltage switching.

10. The converter as claimed in claim 8, wherein the secondary control subsection is adapted to generate one or more gating signals based on one or more status signals received from the primary control subsection and the voltage detection device, the one or more gating signals for keeping the voltage levels of the two DC-link capacitors balanced while the primary control subsection synthesizes the reference signal at the output point of the phase.

11. A method of achieving zero voltage and zero current switching in the converter as claimed in claim 1, the method comprising:
(i) sending to the control section information that is related to the current level at the output of the phase and the voltage level of the DC link capacitors;
(ii) regulating ON and OFF time intervals of each of the main switches and their overlap with the ON state of the auxiliary switches; and
(iii) manipulating the duration of the ON and OFF time intervals of each of the auxiliary switches and each of their overlap time with each of the main switches;
thereby keeping the voltages of the DC link capacitors balanced.

12. The method as claimed in claim 11, wherein information related to a deviation between the voltage levels of the DC-link capacitors is sent through a controller located in a secondary control subsection of the control section, and wherein the controller generates an output based on the information, and wherein a capacitor voltage balancing algorithm factors the output into the charging and discharging times of the DC-link capacitors, thereby keeping the voltages of the DC link capacitors balanced.

13. The method as claimed in claim 12, wherein the controller is a P controller, I controler, PI controller, PID controller, sliding mode controller, deadbeat controller, or a digitaled continuous-time domain controler.

14. The method as claimed in claim 12, wherein the secondary control subsection is implemented in a discrete time domain.
